(19) United States
(12) Patent Application Publication
(10) Pub. No.: US 2006/0148449 A1
(43) Pub. Date: Jul. 6, 2006

(54) Anti-theft system for mobile electronic devices

(76) Inventors: Wolfgang Otto Budde, Aachen (DE); Oliver Schreyer, Herzogenrath (DE)

Correspondence Address: PHILIPS INTELLECTUAL PROPERTY & STANDARDS, P.O. BOX 3001, BRIARCLIFF MANOR, NY, 10510, US

(21) Appl. No.: 10/560,639

(22) PCT Filed: Jun. 4, 2004
(86) PCT No.: PCT/IB04/50841

§ 371 Date: Dec. 13, 2005

(30) Foreign Application Priority Data
May 18, 2003 (EP) 03101778.3

(51) Int. Cl. H04M 3/16; H04M 1/68

(52) U.S. Cl. 455/410

(57) ABSTRACT

A mobile device (12) is presented that comprises a chargeable supply element (20) for supplying the mobile device with electrical power. The mobile device (12) has means for determining a charge level of the supply element (20) and at least one function unit (16). The mobile device furthermore has an authentication unit (22) for evaluating the charge level, wherein, in the event of an increase and/or a sudden change in the charge level, the authentication unit (22) at least restricts the operation of the function unit (16) until an authentication signal is entered. An anti-theft system (10) is furthermore described that comprises the mobile device (12) and a base station 14 having a second authentication unit (23), wherein authentication signals can be conveyed at least from the second authentication unit (23) to the first authentication unit (22) via a data path (30).

The invention relates to a mobile device, an anti-theft system and also a method for protecting a mobile device against theft.

Mobile device having a mobile part and a base station are known. Such devices are optimized as portable or mobile units in regard to their size and their weight so that they can easily be transported. These properties make possible, however, easier theft by unauthorized persons if the devices are left unattended even for seconds.

Modern mobile parts are protected against use by unauthorized persons by means of anti-theft systems. As an example of this, mention may be made, for example, of the use of SIM cards in mobile telephones. A major disadvantage of protection by means of a SIM card is to be seen in the fact that the mobile telephones can continue to be used if the SIM card is replaced.

Furthermore, other mobile devices, for example organizers, etc., can be protected by means of a password so that memories in the organizer are protected against access by an unauthorized person. Disadvantageously, the organizers can nevertheless be used after performing a complete erasure, in which process, however, previously stored data are erased.

GB 2 320 397 A discloses a mobile telephone having an anti-theft system. In this case, use of the mobile telephone is prevented if the mobile telephone is removed from the base station. The proximity of the mobile telephone is monitored by means of a sensor. The sensor also monitors the charging voltage supplied by the charger. However, the sensor may also monitor the storage-battery voltage while it is being charged. As soon as the sensor can no longer detect the voltage or as soon as the voltage drops below a certain threshold value, the mobile telephone becomes unusable or is only cleared for incoming telephone calls. The same occurs if the voltage cannot be measured for a predetermined time interval or if the voltage drops below a certain threshold value for a predetermined time interval.

In this case, the major disadvantage is to be seen in the fact that a security code always has to be entered by means of a keypad into the mobile telephone if the latter is removed from the base station. A further disadvantage is that the mobile telephone remains usable in the event, for example, of replacement of the storage battery and the anti-theft system can thus be circumvented.

It is an object of the invention is to provide a mobile device having an improved anti-theft system that prevents use of the mobile device by unauthorized persons in a simple but efficient way.

According to the invention, this is achieved by a mobile device as claimed in claim 1, an anti-theft system as claimed in claim 4 and an anti-theft method as claimed in claim 10. Dependent claims relate to preferred embodiments of the invention.

The design of the mobile device according to the invention provides an anti-theft system that prevents unauthorized use of the mobile device.

Unauthorized use is prevented in that the mobile device has an authentication unit that monitors the charge level of the supply element. If the charge level of the supply element is increased, the authentication unit demands the entry of an authentication signal. If no authentication signal or an incorrect one is detected, the authentication unit confines the operation of the function unit until an authentication signal is entered or it suppresses operation completely.

Since the mobile device draw electrical energy from the supply element during operation and the charge level consequently always decreases, a stolen device can only be used for a limited time. Any charging of the supply element activates the disabling since it is impossible for an unauthorized user to provide the authentication signal.

In addition to an increase in the charge level, a sudden change can result in an authentication signal being checked. Such a sudden change may be detected, for example, if it is found when the charging state is compared with the last check that the difference is below a specified threshold. A change in the supply element must be suspected in the case of such a sudden change.

The anti-theft system according to the invention provides a base station in addition to the mobile device. The base station has a second authentication unit. Said unit generates the required authentication signal that is routed to the mobile device via a data path. This is particularly advantageous for the user since he does not have to worry about the required authentication signal himself. Preferably, the base station also has a charger, the authentication signal being transmitted with the charging voltage.

Mobile device within the scope of the invention are, for example, portable mobile device that have, for example, a mobile power supply. They may, for example, be devices for storing and for reproducing data and/or for recording and for playing audio and/or video signals. However, communication devices may also be such devices. Such devices are effectively protected by the anti-theft system.

These and other aspects of the invention are apparent from and will be elucidated with reference to the embodiments described hereinafter.

In the drawing:

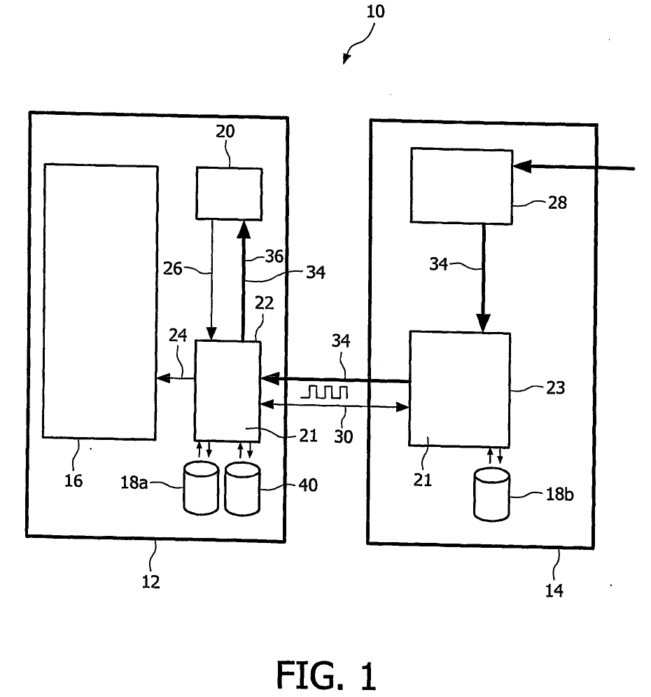

FIG. 1 shows a basic diagram of an anti-theft system.

As FIG. 1 shows, the anti-theft system 10 has a mobile part 12 and a base station 14.

Disposed in the mobile part 12 is a known function unit 16. Here, the function unit 16 represents the actual function of a mobile device and comprises its known units, for example, of an organizer (display, keypad, and/or touch screen, memory, processor, etc.), of a digital camera (image sensor, display, memory, processor, etc.), of an audio player (drive, display, keypad, etc.) of a mobile telephone (display, keypad, microphone, loudspeaker, transmit/receive unit, memory, processor, etc.) or of another mobile electronic device.

The mobile part 12 has a supply element 20 for supplying it with electrical power. The supply element 20 is preferably a rechargeable battery, i.e. a so-called storage battery 20.

Disposed in the mobile device 12 is an authentication unit 22. The base station 14 comprises a further authentication unit 23. The authentication units form an authentication system 21. It should be pointed out that the units shown in FIG. 1 are functional units of the mobile part and the base station, i.e. said units are not necessarily present as separate modules, for example separate electrical circuits in the device. On the contrary, depending on application, said units may be implemented jointly with others, so that, for example, the authentication unit 22 of the mobile part and parts of the function unit 16 can be implemented as program modules that run on a common CPU.

In the exemplary embodiment shown, the authentication system 21 comprises two authentication memory elements 18a, 18b, the authentication memory element 18a being assigned to the authentication unit 22 of the mobile part and the authentication memory element being assigned to the authentication unit 23 of the base station. In addition, the authentication unit 22 has a charge-level memory element 40.

The authentication unit 22 is electrically connected to the function unit 16. The connection is shown by the arrow 24. Furthermore, in the exemplary embodiment shown in FIG. 1, the authentication unit 22 is connected via a data path 26 to the storage battery 20 via which a signal comprising the current charge level is supplied to the authentication unit 22. Appropriate circuits for determining the charge level of a storage battery are known.

The base station 14 is fixed. It serves to store the mobile part 12 and to charge the storage battery 20. For this purpose, it has a mains-supplied charger 28. The mobile part 12 is connected via suitable contacts, for example plug contacts, to the base station 14 so that a charging voltage can be applied. A current path 34 is routed from the battery charger 28 to the storage battery 20 via the authentication units 22, 23. An alternative design of a base station involves a mobile charger, typically designed as a pluggable mains unit.

In FIG. 1, a data path 30 runs parallel to the current path 34. This is preferably implemented in such a way that the charging voltage (direct voltage) has a modulated alternating component so that signals can be exchanged between the authentication units 22, 23.

An alternative design of the data path 30 uses the acoustic signal path between a microphone present in the mobile part and an acoustic signal transducer (loudspeaker) present in the base station. For mobile telephones, in particular, whose microphone is typically fitted in the vicinity of the charging contacts, such a suitable positioning of the acoustic signal transducer in the base station results in a very short acoustic signal path. If the mechanical arrangement of the base station is suitably chosen in that, for example, the lower part of a mobile telephone containing the microphone slips into a charging recess, the acoustic signal transmission is visually and audibly protected from observers. In addition, ultrasonic or infrasonic signals, which are inaudible to human beings, could, of course, be used. During the charging operation, the base station delivers a predefined acoustic signal sequence, for example a tone sequence, that is unique for the particular combination of mobile part and base station.

A further alternative embodiment of the data path 30 consists in the electromagnetic coupling of a short-range wireless transmitter in the base station to a short-range wireless receiver in the mobile station. During the charging operation, signals are exchanged via said electromagnetic coupling.

An authentication criterion (key) is stored in each of the memory elements 18a, 18b, the authentication criteria being assigned to one another.

The design according to the invention of the mobile device comprising the authentication system 21 having the two memory elements 18a, 18b provides an anti-theft system 10 that prevents unauthorized use of the mobile part 12.

Unauthorized use is prevented in that the authentication unit 22 monitors the charge level of the supply element 20. Monitoring takes place continuously or at specified time intervals. During each monitoring, the current charge level determined is compared with the level previously determined and stored in the charge-level memory element 40.

If this comparison reveals that the charge level is equal to or less than at the last monitoring, the charge-level memory element 40 is updated accordingly. The operation of the functional unit 16 then remains unaffected.

However, if the comparison reveals that the charge level has risen compared with the last monitoring (for example, because the storage battery 20 has been exchanged for a charged storage battery or because charging is taking place via the current path 34 of the storage battery 20), the authentication unit 22 demands an authentication signal. Alternatively, the authentication signal may also be demanded if a charging voltage is applied.

The authentication memory 18b in the base station 14 contains a key that is assigned to the content of the authentication memory 18a. The keys may be identical or assigned to one another by a mathematical operation. An authentication signal is created by the authentication unit 23 of the base station 14 on the basis of the content of the authentication memory 18b and transmitted via the data path 30. If the data path 30 is of unidirectional design, this can take place continuously, so that, for example, the authentication signal is always modulated onto the charging voltage. If the data path 30 is of bi-directional design, the authentication unit 22 of the mobile part 12 can also send a request via the data path 30 to which the authentication unit 23 then responds with the authentication signal.

In the example shown, said authentication signal is transmitted via the data path 30 together with the charging voltage, as is indicated by symbolically shown pulses. The above-described alternative designs for implementing the data path 30 can be used in exactly the same way for transmitting the authentication signal. The authentication signal emitted by the authentication unit 23 is checked for agreement with the content of the memory element 18a. Said agreement may consist in the content of the authentication signal being identical to the stored content of the memory element 18a. However, the check may also comprise combining the authentication signal by a mathematical operation with the stored content of the memory element 18a and establishing an agreement on the basis of the result, as is known, for example from asymmetrical encryption/authentication methods.

If the testing of the authentication signal in the authentication unit 22 reveals agreement, further operation of the mobile part 12 takes place and, possibly, the operation of charging the storage battery 20 continues unhindered.

If the check reveals, however, that there is no agreement (for example, even because no authentication signal whatsoever has been received), the authentication unit 22 activates a security mode of the mobile part 12 because it is to be suspected that unauthorized use is being made of the mobile part.

There are several options for operating the mobile part 12 in the security mode. On the one hand, a current path from the storage battery 20 to the function unit 16 can be interrupted so that further operation is not possible. Another option is to transmit a signal to the function unit 16 via the connection 24 so that the latter interrupts its operation and refers the user to the absent authentication. Finally, it is also possible for the function unit 16 to be transferred to a limited operating mode in which only emergency functions (for example, emergency calls) are possible or, in the case of a mobile telephone, for example, only incoming calls are possible or, in the case of a digital camera, only the emission of photos but not new snaps are possible. In addition, it is possible that the authentication unit 22 interrupts the current path 34 and consequently suppresses further charging of the storage battery 20. The abovementioned measures may be combined in a suitable way.

The security mode is entered, for example, if the mobile part 12 is stolen from the authorized user and the authentication unit 22 does not detect an authentication signal on the data path 30 because an attempt is made to charge the storage battery 20 of the mobile part 12 directly on a conventional charger.

These measures ensure that the mobile part 12 is unusable for an unauthorized person. Provision can be made that the authentication unit 22 additionally monitors the charge level of the storage battery 20 for failure to exceed a fixed minimum threshold and then likewise demands an authentication. The time for which an unauthorized user can use the device after stealing it can thus be limited. Depending on the desired degree of data security, it is also possible, by completely switching off the function unit 16 or as a result of limited operation, to ensure that the data stored in the mobile part 12 is not disclosed to an unauthorized person.

The charge-level memory element 40 is expediently designed as a non-volatile memory so that the value of the stored charge level of the supply element 20 is still available even after the mobile part 12 is switched off and even if the storage battery 20 has been removed from the mobile part 12 for an indefinite time or has been replaced. The memory elements 18a, 18b are also designed as non-volatile memories.

It goes without saying that it is possible within the scope of the invention to keep a plurality of mobile parts serviceable by means of a common base station. This only requires an authentication signal identical to or assigned to the authentication signal of the memory element of the base station to be stored in the respective memory element of the mobile parts.

Preferably, the respective authentication criteria are entered in the respective memory elements 18a, 18b as a common key during the industrial assembly as part of the production and assignment of the individual system modules to one another. The memory elements 18a, 18b consequently have a common secret.

Alternatively, the memory element 18b may have an arbitrary authentication criterion entered during the industrial assembly. In that case, an authentication signal is established when the mobile part 12 is first used or when the storage battery 20 is first charged and is stored in the memory 18a, i.e. an assignment takes place. Mobile part 12 and base station 14 consequently have a common secret and this ensures that no other charger can be used with the mobile part.

It goes without saying that it is also within the scope of the invention if the respective authentication criteria are entered or changed by the authorized user.

In one further aspect, the memory element 18b may store a multiplicity of authentication signals so that a multiplicity of mobile parts can be operated with the base station 14. In that case, it is advantageous that a data exchange takes place in both directions between the authentication units 22, 23 by means of the connection 30. Under these circumstances, the memory element 22 transmits its authentication signal to the memory element 23, which verifies the agreement of the authentication signal.

Within the scope of the invention, the base station may expediently also be a simple charger having a jack plug or the like. In that case, the authentication unit 23 would be disposed in the charger itself.

In a further design (not shown), the storage battery 20 may likewise have a memory element that is not shown. Stored in said memory element is an authentication signal that agrees with the authentication signal in the memory element 18a. Preferably, the authentication signals in the respective memory elements 18a, 18b and that of the memory element in the storage battery 20 are identical. If a new storage battery 20 is inserted into the mobile part 12, the authentication unit requests the authentication signal of the new storage battery because the stored charge level of the replacement storage battery is lower than the charge level of the new one or, more generally speaking, the charge level of the new storage battery differs from the stored level of the old storage battery. If the authentication signals do not match or are not assigned, the authentication unit 22 activates the security mode.

In particular, the mobile part 12 is frequently separated when traveling from the base station 14 for a fairly long time. This often requires the insertion of replacement storage batteries if there is no possibility of charging. It is therefore advantageous within the scope of the invention if the respective storage battery has an authentication signal matching the authentication signal of the memory element 18a. Advantageously, the mobile part 12 can consequently be used with all the storage batteries provided with the matching authentication signal.

So that there is no possibility of circumventing the theft protection in the case of this alternative design, the storage batteries used in that case have, for their part, an authentication unit corresponding to the above-described unit 22 that ensures that the storage battery can be charged only by supplying the matching authentication signal.

1. A mobile device comprising
a chargeable supply element (20) for supplying the mobile device (12) with electrical power,
means for determining a charge level of the supply element (20),
at least one function unit (16);
and a first authentication unit (22) for evaluating the charge level, wherein the authentication unit (22) monitors an authentication signal in the event of an increase and/or a sudden change in the charge level and if the authentication signal is absent or incorrect, it at least limits the operation of the function unit (16).

2. A mobile device as claimed in claim 1,
in which the authentication unit (22) has at least a first authentication memory element (18a) for storing an authentication criterion
wherein the authentication unit (22) checks the authentication signal by means of the authentication criterion and, in the event of agreement, enables the operation of the function unit (16).

3. A mobile device as claimed in claim 1,
in which a value of the charge level of the supply element (20) can be stored in a charge-level memory element (40),
wherein the charge-level memory element (40) is preferably a non-volatile memory.

4. An anti-theft system comprising
a mobile device (12) as claimed in claim 1—and a base station (14),
wherein the base station (14) has a second authentication unit (23),—and the authentication units (22, 23) can be connected via a data path (30) in such a way that the authentication signals can be conveyed at least from the second authentication unit (23) to the first authentication unit (22).

5. A system as claimed in claim 4, in which
an electrical supply path (34) is present from the base station (14) to the mobile part (12) for charging the supply element (20).

6. A system as claimed in claim 5, in which
the data path (30) und the supply path (34) have at least partly common electrical conductors,
wherein the supply path (34) preferably has at least one supply voltage and data are transmitted on the data path (30) by modulating the supply voltage.

7. A system as claimed in claim 4, in which
the data path (30) is implemented in the form of acoustic and/or electromagnetic wireless transmitting and receiving units.

8. A system as claimed in claim 4, in which
there is a bi-directional data path (30) between the base station (14) and the mobile part (12).

9. A system as claimed in claim 4, comprising
a plurality of mobile devices (12)
and a base station (14),
wherein authentication criteria for each of the mobile devices (12) are stored in a memory element (18b) of the base station (14).

10. A method for protecting a mobile device against theft, in which
the charge level of a chargeable supply element (20) is determined—and, in the event of an increase and/or a sudden change in the charge level, the operation of a function unit (16) is at least restricted until an authentication signal is entered.
